(19) United States
(12) Patent Application Publication
(10) Pub. No.: US 2011/0029407 A1
(43) Pub. Date: Feb. 3, 2011

(54) SYSTEM AND METHOD FOR A COMMISSION-BASED NETWORK (COBANET)

(76) Inventors: Hugues Courchesne, Drummondville (CA); Charles Bombardier, St-Denis-de-Brompton (CA)

Correspondence Address: BENOIT & COTE, s.e.n.c., 1001, DE MAISONNEUVE BOULEVARD WEST, SUITE 210, MONTREAL, QC, H3A 3C8, CA

(21) Appl. No.: 12/935,898

(22) PCT Filed: Apr. 6, 2009
(86) PCT No.: PCT/CA09/00469

§ 371 Date: Sep. 30, 2010

Related U.S. Application Data
(60) Provisional application No. 61/042,532, filed on Apr. 4, 2008.

(51) Int. Cl. G06Q 30/00

(52) U.S. Cl. 705/26.41

(57) ABSTRACT

The present description proposes a system and method for a commission-based network. More particularly, in a server allowing electronic communications thereto and therefrom, there is provided a method for implementing a commission-based network (COBANET) over the data communication network. The method comprises: storing (200) on a memory device accessible by the server, pricing information and commission information associated with products offered for sale by a vendor; (202) receiving an electronic communication from a user acting as an agent, the electronic communication specifying a referred product corresponding to a product selected from products offered for sale by a vendor, and a contact identification; (204) generating a transaction schedule associated with the referred product, based on the pricing information and the commission information; upon receiving an electronic purchase request for the referred product, from a buyer corresponding to the contact identification, determining (208): a purchase price required from the buyer; a commission for the agent; and a payment due to the vendor, based on the transaction schedule; and outputting (210) an electronic notification over the data communication network, the electronic notification being indicative of at least one of the commission and the payment for respectively at least one of the agent and the vendor.

### CROSS-REFERENCE TO RELATED APPLICATIONS

This application claims convention priority from U.S. provisional application No. 61/042,532 filed Apr. 4, 2008, which is hereby incorporated fully by reference.

### TECHNICAL FIELD

This description relates to the field of servers for managing web-based transactions. More particularly, this description relates to commission-based systems and method.

### BACKGROUND

With the evolving popularity of online trading and advertising, it has become very common to see vendors offer their products and/or services for sale to potential buyers over the Internet. Online purchases and transactions have also become increasingly popular and thus many successful vendors now offer online ordering and payment. To increase chances of sales, vendors generally try to increase their online presence so as to attract as much potential buyers to their Web site(s). One way is to use online advertisement on other affiliate web sites for example.

While increasing advertisement is one way of reaching out to potential buyers, it has been shown that word-of-mouth is often the best approach to increasing one's market. Trading networks have however failed to successfully tap into the power of social networking in order to close off sales.

There is thus a need to address shortcomings associated with the prior art.

### SUMMARY

The present description proposes a system and method which is meant to address at least some of the above-mentioned issues associated with the prior art. More particularly, the proposed system and method enables a linking of parties involved in trading or selling of goods and/or services over a data communications network, and accordingly determines amounts which are deemed payable to parties which can be said to be accountable for a given sale.

Therefore, in accordance with an embodiment, there is provided a system for implementing a commission-based network (COBANET) over a data communication network. The system comprises a server accessible over the data communication network to allow electronic communications thereto and therefrom; a memory device accessible by the server, the memory device storing pricing information and commission information associated with products offered for sale by a vendor; and an application module storing instructions accessible for execution by the server. The instructions allow the server to: receive an electronic communication, from a user acting as an agent, specifying a referred product corresponding to a product selected from the products offered for sale by the vendor, and a contact identification; based on the pricing information and the commission information, generate a transaction schedule associated with the referred product; upon receiving an electronic purchase request for the referred product, from a buyer corresponding to the contact identification, determining, based on the transaction schedule: a purchase price required from the buyer; a commission for the agent; and a payment due to the vendor; and output an electronic notification over the data communication network, the electronic notification being indicative of at least one of the commission and the payment for respectively at least one of the agent and the vendor.

In accordance with another embodiment, there is provided, in a server allowing electronic communications thereto and therefrom, a method for implementing a commission-based network (COBANET) over the data communication network. The method comprises: storing on a memory device accessible by the server, pricing information and commission information associated with products offered for sale by a vendor; receiving an electronic communication from a user acting as an agent, the electronic communication specifying a referred product corresponding to a product selected from products offered for sale by a vendor, and a contact identification; generating a transaction schedule associated with the referred product, based on the pricing information and the commission information; upon receiving an electronic purchase request for the referred product, from a buyer corresponding to the contact identification, determining: a purchase price required from the buyer; a commission for the agent; and a payment due to the vendor, based on the transaction schedule; and outputting an electronic notification over the data communication network, the electronic notification being indicative of at least one of the commission and the payment for respectively at least one of the agent and the vendor.

In the present description, the term “product” is intended to refer to any good, service, item, tangible or intangible object that may be purchased or traded.

### BRIEF DESCRIPTION OF THE DRAWINGS

Further features and advantages of the present invention will become apparent from the following detailed description, taken in combination with the appended drawings, in which:

FIG. 1 is a schematic view of a commission-based network (COBANET) according to an embodiment;

FIG. 2 is a schematic view of a COBANET server system according to an embodiment;

FIG. 3 is a schematic view of a transaction table once completed for a purchase request, in accordance with an embodiment;

FIG. 4 is a block diagram illustrating a method for a commission-based network in accordance with an embodiment; and

FIG. 5 is a block diagram illustrating a method for a commission-based network in accordance with an embodiment.

It will be noted that throughout the appended drawings, like features are identified by like reference numerals.

### DETAILED DESCRIPTION

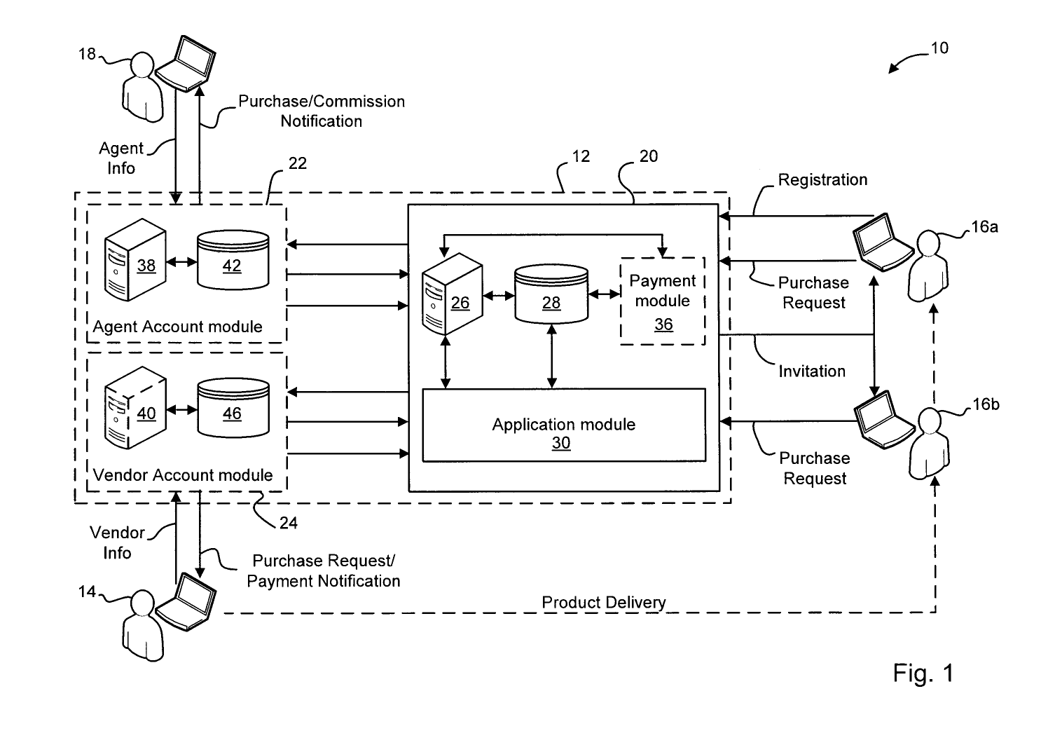

Referring now to the drawings, and more particularly to FIG. 1, there is illustrated a COmmission-BAsed NEtwork (COBANET) 10, implemented over a data communications network in accordance with an embodiment.

The proposed COBANET 10 is meant to apply the networking power of the World Wide Web (Internet or other types of WANs) to sell products (or services) offered for sale by vendors, to users across the network, with the help of users who sign up as intermediary sales agents (or simply agents). Users are enticed to act as agents in view of being paid a commission for each sale resulting from their leads. Agents can also select for which product they wish to act as an agent. Agents in turn entice their own contacts to purchase the products they refer. Once a sale is closed, their contacts become buyers. Their contacts may also register to act as agents, or as vendors if they hold an inventory of products

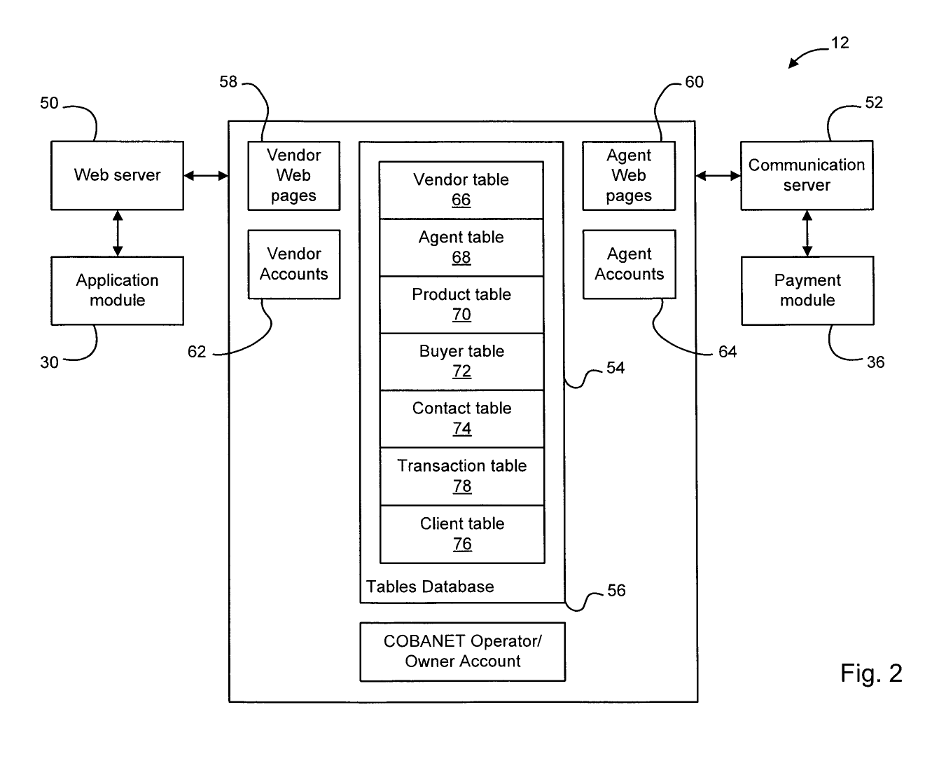

The COBANET 10 has a server system 12, which may take a variety of forms. The server system 12 can however be generally described as a processing machine accessible via a data communications network, having various hardware modules, such as schematically illustrated in FIGS. 1 and 2, which are implemented to cooperatively perform a series of actions to establish links and manage electronic communications between users over the data communication network, as described herein.

As illustrated in FIG. 1, users of the COBANET 10 register with the server 12 under at least one of three different categories: to act as a vendor 14, as a buyer 16a or 16b (also referred to as a contact or a client where applicable), or as an agent 18.

Vendors 14 are sellers of products, such as retail merchants, manufacturers, industrials, or providers of services. Vendors 14 register with COBANET to sell their products with the help of agents 18 in COBANET and their own network of clients. Their incentive to register is that they are given the opportunity to use the help of many agents 18 without having to provide them a basic salary.

Users who are buyers 16a and 16b may be also registered as an agent 18 or as a vendor 14. An agent 18 can also be registered as a vendor 14 as well. Vendors 14, contrary to agents 18, typically hold an inventory of products or are the direct providers of a service; they are responsible for product or service shipment and delivery. Agents 18 simply act as an intermediary sales agent; they do not actually provide the products/services once sold. Their role is to find leads to promote the sale of a specific product or service.

COBANET 10 may be offered for free to users or to specific types of users, as desired by the operator or owner of the system server 12. As a free service, Vendors 14 are free to publish (or post) their products over COBANET 10, while buyers 16a/16b may freely view the products posted by the vendors 14. The agents 18 are also able to register to the server system 12 on a free basis. Different types of registration accounts may alternatively be offered, each type providing options and/or advantages in return of a monthly subscription for example.

Still referring to FIG. 1, the system server 12 has a main module 20 having access to a data communication network (not shown), an agent account module 22 and a vendor account module 24. Both the agent account module 22 and the vendor account module 24 are optional and may be incorporated as a single unit with the main module 22, as exemplified by FIG. 2.

In FIG. 1, the main module 20 has a main server 26, a memory device 28, an application module 30 and a payment module 36. Both of the optional agent account module 22 and vendor account module 24 have their respective servers 38, 40 and memory devices 42, 46 in communication with the main module 20. The application module 30 has instructions which implement the main server 26 in such a way that the following described actions are performed on the network.

Vendors 14 register with the server system 12 by entering vendor information, which includes at least their identification information, details on products they offer for sale and pricing and commission information pertaining to each of these products. Vendors 14 may also provide a list of client identifications which can be used by the system server 12 to identify buyers who may be interested in making purchases. Vendor information may be stored in the vendor account module 24 or main module 20.

Once the vendor information is registered with the system 12, either one of servers 26 and 40 generate a Web page for the vendor 14 (with a URL address such as: www.COBANET.com/Vendor1 for example). The web page posts information on the products listed by the vendor 14, including respective pictures and details of a product, its pricing and commission information. Additional information can also be posted, such as professional information about a company of the vendor 14, or any other optional information customized to the desires of the vendor 14. The vendor web pages may be stored on either one of the memory devices 28 and 46.

Vendors 14 can later update their information such as details on the products they offer and add products. Updates may be directly entered from their web pages, or by uploading updates using an API module for example.

In addition or alternatively to the above described Web page generation, an affiliate web site may be used to display a vendor's products. The affiliate web site may be operated by any operator (the vendor or a different party). A script provided by an operator owner of COBANET is inserted into the affiliate web page to link the COBANET system server 12 to an external server (not shown) on with the affiliate web site is hosted. In this way, a user can browse through products of a vendor, or referred products of an agent, displayed on the affiliate web site, as if accessing the COBANET 10. The user's browser may also be re-directed to a URL address of the system server 12 when the user clicks on one of the product postings. The affiliate web site can be any digital content hosted by any server or group of servers (not shown) which are external to COBANET 10 and accessible over the data communication network.

The pricing information is a price at which the vendor 14 wishes to sell a product, while the commission information is indicative of a commission amount the vendor 14 is ready to provide to any intermediary sales agent 18 who helps sell the product. Commission information can be, for example, a percentage (%) of a final purchase amount or price fixed by the vendor for a given product. For example, a Vendor 14 posts a car for sale at a price of $10,000, with a promise to a 7% commission percentage of the sale price to any agent who helps sell the car. When the sale is made, the vendor gets $9,300, leaving a $700 commission to a helping agent 18.

Still referring to FIG. 1, agents 18 register with the server system 12 by entering agent information, which includes at least their identification information, specifies the products offered for sale by the vendors 14 they wish to refer as referred products, and an identification of at least one of their contacts who may be interested in their referred products. These contact identifications are used by the system server 12 to identify social relations between buyers 16a/16b and agents 18. The agents may also use the system server 12 to send invitations to their contacts enticing them to access the network 10 and make purchases of their referred products. Finally, agent information may further identify a list of preferred vendors for one referred product, the list indicating a level or preference for each vendor.

Agent information may be stored in the agent account module 22 or main module 20. Once the agent information is registered with the system 12, either one of servers 26 and 38 generate a Web page for the agent (with a URL address such as: www.COBANET.com/agent1 for example). The web page posts information on the referred products, with any information about the agent 18, which can be customized to the agent's desires. Additional product reviews can for example be added, along with any other promotional information. The agent web pages may be stored on either one of the memory devices 28 and 42.

In addition, and similarly to the above described use of an affiliate web site posting products available for sale by any vendor, referred products chosen by agents may also be posted on an affiliate web site external to the COBANET. This technique may be advantageous to agents in order to increase their online visibility.

Still referring to FIG. 1, the main module 20 generates a transaction schedule associated to each product posted on sale by each one of the vendors 14. This transaction schedule is based on the pricing and commission information, as well as all the products, and optionally the referred products, which are provided by all the vendors 14, and optionally the agents 18. The transaction schedule is stored on the main memory device 28 and serves to determine what payments are owed and by which party in case of a purchase.

When a buyer 16a or 16b visits an agent web page or a vendor web page hosted by the system server 12, and decides to place an order for a purchase of an item posted thereon, the main module 20 receives an electronic purchase request for that item. The main server 26 then processes the request. One of the actions performed by the main server 26 in this process is to determine a purchase price or amount required from the buyer (16a/16b) for that purchase, a commission to be paid to the agent 18 responsible for the sale, and an amount for payment to the vendor 14. An electronic notification is then outputted by the system server 12 over the data communication network, to indicate at least the commission for the agent 18 and the payment for the vendor 14. A completed transaction schedule is subsequently sent to the payment module 36. Before the purchase is finalized by the payment module 36 or by any other payment system, however, the vendor 14 may decide to validate or to decline the purchase request by either accepting or refusing the terms as set in the notification.

The payment module 36 is optional. An external payment service may be used or integrated thereto. Payment module and service used is similar to Paypal or Google Checkout for example.

In an optional implementation, an operator or an owner of the COBANET server system 12 keeps a percentage of the commission accorded by a vendor to an agent for a sale of one of their products. For example, for a $700 commission, an AGENT 18 could receive $420 (or 60% of the commission) and the remaining 40% or $280 goes to the operator or owner of the COBANET system server 12. The transaction schedule is adaptable to such an implementation.

If the buyer 16a places an order for a purchase of an item corresponding to multiple referred products from multiple agents without specifying from which agent 18 he/she wishes to place the purchase order, the main server 26 requests an identification of the buyer 16a, determines if a match exists with one of the contact identifications provided by the agents, and where multiple matches are found, evaluates the social relations between the matching contacts and the respective agents to determine a degree of separation. The server then selects the socially closest agent 18 as the agent responsible for the sale. When more than one agent 18 have equivalent degrees of separation with the buyer 16a, an auction process with decreasing bids is performed to obtain a lowest price for the product or service. Competing agents can therefore decide to cut their commission amounts to potentially make a sale.

Still referring to FIG. 1, agents 18 may specify the products they wish to list as referred products on their web page by selecting products posted on vendor web pages. A selling request or notification may further be sent by the system server 12 to a vendor 14, to notify the party that an agent 14 has referred one of their products. The selling request can specify a commission desired by the agent, which the vendor may accept or refuse until parties agree.

Agents 18 may also refer multiple vendors 14 for a single referred product, provided all of these vendors offer the product corresponding to the referred product. In this case, the preference list provided by the agent 18 is used to select a vendor wining the purchase. If a buyer 16b does not specify a vendor in his/her purchase request, the system server 12 uses the preference list of the agent 18 to determine the vendor who will make the sale and furnish the purchased product.

Alternatively or in addition to the above, agents 18 may identify products which are not already offered by a vendor 14 registered with the system server 12. In this alternative, the system server 12 allows the agent 18 to enter a description of the product he/she wishes to refer, including an identification of a potential vendor of that product. The description may be a link to external digital content available over the data communication network, entered directly by the agent or by recording a selection of digital content found on a web page being viewed by that agent. The identification of the potential vendor may be an electronic address, a telephone number or the like. When an electronic address is provided, the system server 12 sends a selling request such as notice of the agent's referral to the potential vendor, including an invitation to join the COBANET 10 to post products for sale thereon. In the case where no electronic address is provided for the potential vendor, the agent 18 may contact the potential vendor by telephone to discuss the basis of their alliance and register the potential vendor with the COBANET 10 in his/her name, as a vendor of products corresponding to the referred products chosen by the agent.

Agents 18 can specialize in a given category of products and select as referred products only products from that category. In one example, an agent 18 decides to post all sports cars he/she finds on the pages of VENDORS 14 such as “Montreal Auto Prix”, “H. Grégoire”, “Auto Hebdo”, or any other car dealer or automobile parts supplier for example. This AGENT 18 becomes a sports cars specialist.

Now referring to FIG. 2, system server 12 is illustrated as a single unit having a dedicated web server 50, a dedicated communication server 52, the application module 30 and payment module 36, and several databases stored in a memory device or in a combination of different memory devices (not shown) accessible by the web 50 and communication servers 52. The databases include a Tables database 54, a COBANET operator/owner account database 56, vendor web page database 58, agent web pages database 60, and vendor and agent accounts databases 62 and 64 respectively.

While FIG. 2 illustrates the system server 12 as a single unit, it is possible that a number of the above listed databases be located externally, on remote memory devices for example. These may communicate with respective servers though the data communication network.

The Tables database 54 stores a vendor table 66, an agent table 68, a product table 70, a buyer table 72, a contact table 74, a client table 76 and a transaction table 78.

The vendor table 66 is a list identifying registered vendors 14, with indexes to their information, their account and their web pages. Similarly, the agent table 68 is a list identifying registered agents 18, with indexes to their information, their account and their web pages. The product table 70 lists all the products and associated vendors 14, with at least indexes to their associated pricing and commission information. The buyer table 72 lists users who have previously made purchases with the system 12. The contact and client tables 74 and 76 are lists of contacts associated with each agent 18 and clients associated with each vendor 14. Finally, the transaction table 78 is generated by the system server 12 using the information primarily from the product table 70. The transaction table 78 lists transaction schedules associated with each product for each vendor selling that product. A transaction schedules is a framework of fields, some of which are to be completed once a purchase request is received from a given buyer 16a/16b.

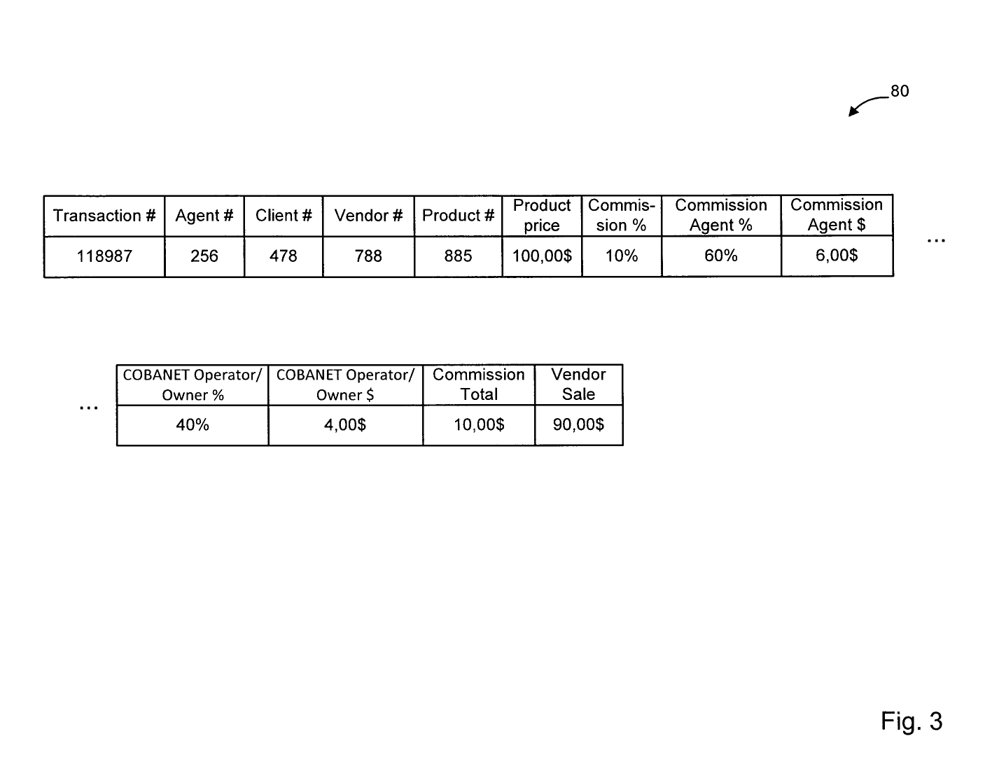

FIG. 3 illustrates a completed transaction schedule 80 for one trade, once the electronic purchase request is received and the agent 18 and vendor 18 responsible are determined.

Referring to both FIGS. 2 and 3, when a buyer 16a or 16b sends a purchase request to the system 12, the transaction schedule 80 for the product the buyer 16a or 16b whishes to purchase is used, and empty fields in the transaction schedule 80 are filled. Incomplete fields include the transaction number, agent, client or buyer, and vendor identifications. All other fields are pre-filled using pricing and commission information provided by the vendor 14.

Once the purchase request is received form an identified buyer 16a or 16b for a product associated to an identifiable agent 18 and vendor 14, the incomplete fields are filled and the transaction schedule 80 is complete and ready to be optionally validated by the vendor 14 and processed for respective payments.

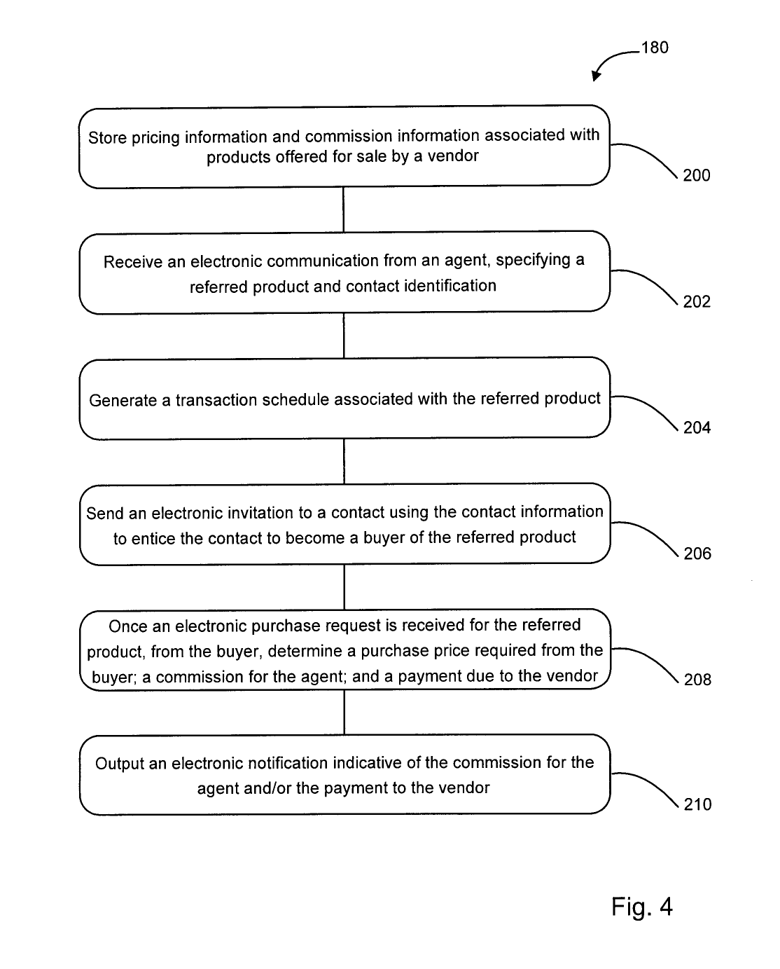

FIG. 4 illustrates steps of a method 180 or a commission-based network in accordance with an embodiment. The method is performed by a system server 12 having an application module with instructions allowing the system server to be implemented the method as described hereinbelow.

In step 200, pricing information and commission information associated with products offered for sale by a vendor is stored on a memory device accessible by the server.

In step 202, an electronic communication is received from a user acting as an agent. The electronic communication specifies a referred product corresponding to a product selected from products offered for sale by a vendor, and a contact identification associated with a contact of the agent.

In step 204, a transaction schedule associated with the referred product is generated based on the pricing information and the commission information.

In step 206, which is optional, an electronic invitation is sent to the buyer using the contact information. The electronic invitation entices the buyer to visit a web page of the agent displaying the referred product to purchase the referred product.

In step 208, once an electronic purchase request is received for the referred product, from a buyer corresponding to the contact identification, a purchase price required from the buyer; a commission for the agent; and a payment due to the vendor are determined based on the transaction schedule.

In step 210, an electronic notification is outputted over the data communication network, the electronic notification being indicative of at least one of the commission and the payment for respectively at least one of the agent and the vendor.

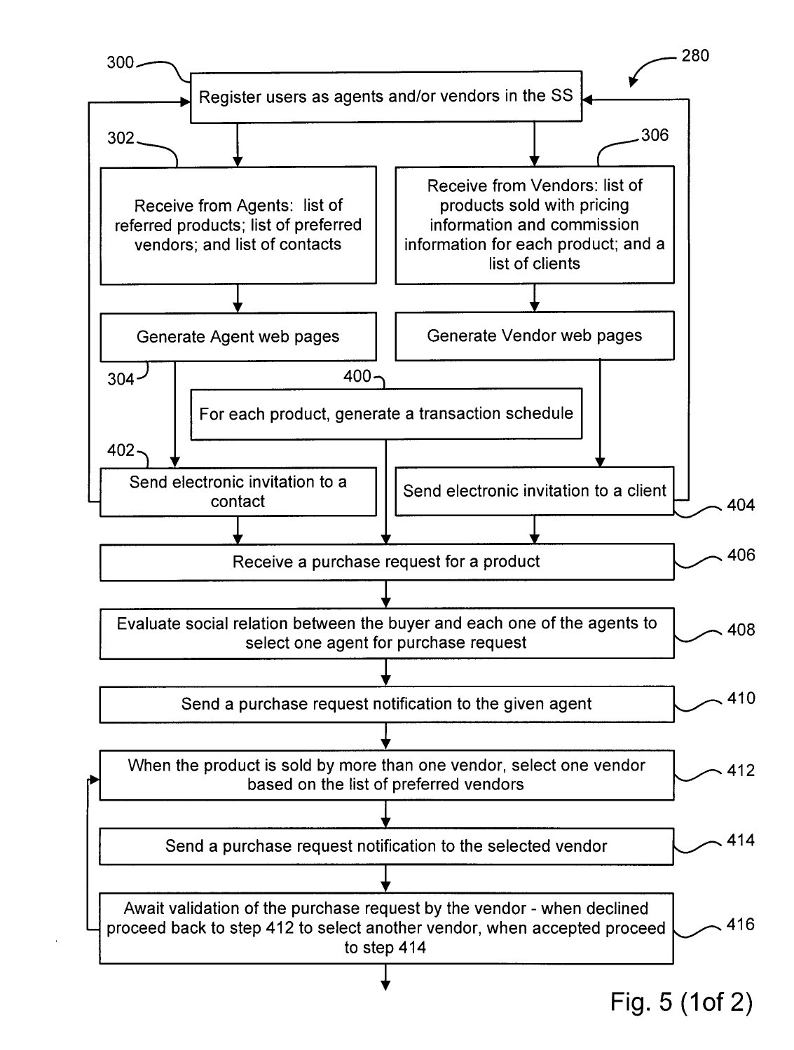

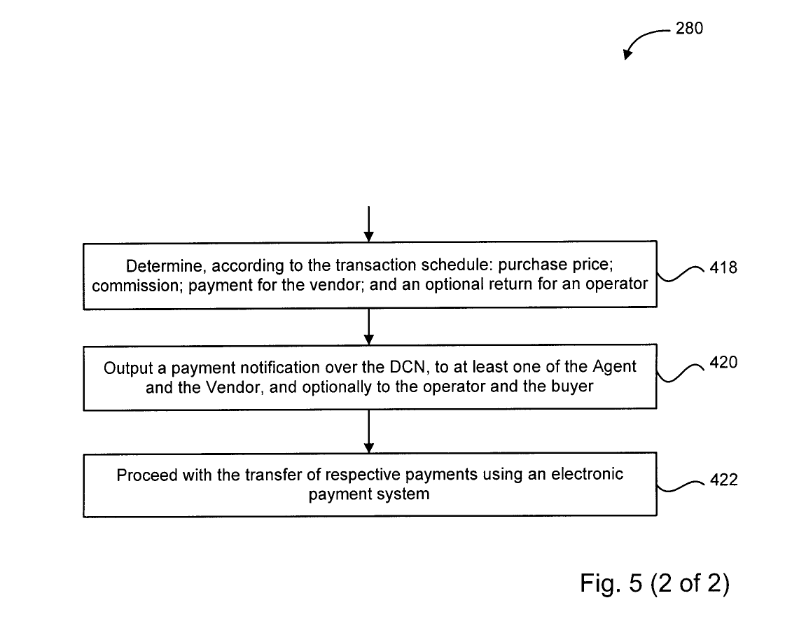

FIG. 5 illustrates steps of a method 280 in accordance with another embodiment where additional steps are added to the method described by FIG. 4.

In step 300, users accessing the system server (SS) via a data communications network (DCN) enter at least their identification information, which is received by the system server. The system server registers these users as agents and/or vendors by recording their ID information in an Agent Account Database and/or a Vendor Account Database.

In step 302, a list of referred products chosen by each Agent is received from each Agent via the DCN. The referred products are chosen from the products sold by the vendors. An optional list of preferred vendors and a list of contacts of the agent are also received.

In step 304, an Agent web page is generated for each registered agent. The web pages each show the referred products promoted by their respective Agent, for being displayed to users browsing on the COBANET network, over DCN.

In step 306, a list of products sold by each Vendor, including pricing information and commission information for each respective product is received from each Vendor, via the DCN, for entry into the system server. A list of respective client identification is also optionally received and stored.

In step 308, a Vendor web pages showing the products offered for sale a vendor is generated by the system server. The web pages are used to display these products to users visiting the COBANET network over DCN.

Step 400 is similar to step 204 of FIG. 4.

In step 402, the system server sends electronic invitations via the DCN, on behalf of each agent, to the contacts provided by each Agent to entice them to purchase their referred product, similar to step 206 of FIG. 4. If contacts receiving the invitations wish to register, the method proceeds back to step 300.

In step 404, the system server sends electronic invitations on behalf of each vendor via the DCN, to the clients provided by each vendor. If clients receiving the invitations wish to register, the method proceeds back to step 300.

In step 406, the system server receives a purchase request from a buyer accessing any one of the Vendor and the Agent web pages hosted by the system server on the network. The purchase request provides an identification of the product for which the purchase request is placed and an identification of the buyer. When the product corresponds to a referred product available for sale via a given Agent; an identification of that agent is also provided in the request. If no agent has selected that product as one of their referred products, the purchase request will have no entry under the agent identification. Similarly, if the purchase is placed in respect of a specific product from a specific vendor, vendor identification is also provided in the purchase request, otherwise this entry is not included.

The system server then proceeds to fill in the entries of the transaction schedule.

In optional step 408, when the product specified in a purchase request corresponds to multiple referred products from a plurality of agents, the system server evaluates a social relation between the buyer and the plurality of agents to determine a degree of separation between the buyer and each one of these agents. The agent having the closest relationship with the buyer, in accordance with the contact identifications that are found in the contact table for that agent, is selected as the wining agent responsible for that purchase. The identification of that responsible agent is thus entered in the agent field of the transaction schedule.

In optional step 410, once the agent who is responsible for a purchase is determined, the system server optionally sends a notification of the purchase request to that agent. Information in the associated transaction schedule may be part of the notification.

In optional step 412, when the product is sold by more than one vendor, the system server selects one vendor based on the list of preferred vendors provided by the agent responsible for the purchase. The identification of that vendor is thus entered in the vendor field of the associated transaction schedule.

In optional step 414, a purchase request notification is sent to the responsible vendor, with information from the transaction schedule associated to the purchase request.

In step 416, when the vendor receives this notification, he/she has the choice to validate or not the transaction by sending a reply validation to the system server. Validation of the notification enables payments to proceed automatically or at a later time. When the selected vendor declines a validation of the purchase request notification, another vendor who sells the same product is chosen. Alternatively, the method may proceed back to step 412, where the vendor selected is another vendor chosen from the list preferred vendors provided by the agent responsible for the purchase. Once the notification is validated, the method proceeds to step 418.

Step 418 is similar to step 208 of FIG. 4, though an optional return to an operator of the system may also be included in the determination of payments to each party.

Step 420 is similar to step 210 of FIG. 4. Payments determined for each party is outputted for their notification. Notifications can be sent in any electronic communication format.

In step 422, the transfer of respective payments is performed using any electronic payment system.

In the above described method 280, steps 408 to 410 can be adapted such that an agent can gather potential purchase requests sent from members in his/her network of contacts until a notification is sent to the vendor and the purchase is processed. The contacts which could become clients may also inform their agent about the purchases they wish to make.

The above method 280 can also have another step of sending a selling request to a vendor to notify the vendor that an agent has specified a referred product which corresponds to a product selected from the products offered for sale by that vendor. The selling request may indicate a requested commission that the agent would like, for approval by the vendor.

Other Optional Functionalities:

The system server 12 may provide multiple additional services over the network. For example, the application module and the server may support a search engine to enable searches to be done by users, based on a manufacturer, a year/age of a product, a pricing, or any other characteristic of a product searched. Searches may also be performed on the agent database. One will also look for pages from agents to find specialists for a type of product, whom will have taken the time to learn about products from many vendors. Most present agents may also post items on COBANET without having to leave their present jobs thereby permitting to continue receiving commissions.

The above-described system is implemented to allow that each registered user invites contacts and/or clients by sending electronic invitations to entice them to visit their web sites on COBANET and make purchases. As an example, vendors may invite their clients, while agents may invite their friends, colleagues and/or family members. To further make the listing of contacts easier to users, the system server 12 optionally performs an automated scanning of email address lists or contacts from various email service providers and software, such as Outlook, Gmail and Hotmail. The COBANET system server 12 may also support the distribution of monetary incentives (bonuses) to users who have invited their contacts. The incentives can take various forms, such as pre-fixed cash payments or amounts determined based on the transactions generated by the invited contact through purchases or sales as a registered vendor or agent.

Other types of incentives can be implemented to ensure a growth of the COBANET 10. As an example, agreements with web-based social networks, such as LinkedIn, Facebook, MySpace, MSN, Google groups, community sites, blogging sites or online organizations, can provide that an operator or owner of the COBANET system server 12 gives some monetary amount or service in exchange of having their members register to the COBANET via their respective web sites. Alternatively, these organizations may simply advertize or promote the COBANET.

The system server 12 may propose a vendor generator tool to help agents find vendors within COBANET or anywhere in a given market for example. The tool provides the ability to search over a wide range of data accessible over the data communication network on which COBANET is implemented. Users are also able to subscribe to a newsletter or to receive electronic notices about new products/services or vendors added to the COBANET, or about any events such as agent auctions occurring.

Electronic notifications and communications referred hereinabove can take the form of emails, SMS, MMS, text messaging, audio messaging or any other type of communication method permitting the relay of a communication over the data communication network.

COBANET as above described can be implemented to offer a series of additional functionalities and services in addition to the above described.

The embodiments described above are therefore intended to be exemplary only. The scope of the invention is therefore intended to be limited solely by the scope of the appended claims.

1. A system for implementing a commission-based network (COBANET) over a data communication network, the system comprising:
a server accessible over the data communication network to allow electronic communications thereto and therefrom;
a memory device accessible by the server, the memory device storing pricing information and commission information associated with products offered for sale by a vendor; and
an application module storing instructions accessible for execution by the server, the instructions allowing the server to:
receive an electronic communication, from a user acting as an agent, specifying a referred product corresponding to a product selected from the products offered for sale by the vendor, and a contact identification;
based on the pricing information and the commission information, generate a transaction schedule associated with the referred product;
upon receiving an electronic purchase request for the referred product, from a buyer corresponding to the contact identification, determining, based on the transaction schedule: a purchase price required from the buyer; a commission for the agent; and a payment due to the vendor; and
output an electronic notification over the data communication network, the electronic notification being indicative of at least one of the commission and the payment for respectively at least one of the agent and the vendor.

2. The system of claim 1, wherein the application module stores additional instructions allowing the server to:
send, to a buyer corresponding to the contact identification, an electronic invitation to purchase the referred product.

3. The system of claim 1, wherein the application module stores additional instructions allowing the server to:
receive an other electronic communication, from an other user acting as the vendor, detailing the products offered for sale, including the pricing information and the commission information, for storage in the memory device.

4. The system of claim 3, wherein the other electronic communication further comprises an identification of a client of the vendor, the application module allowing the server to further send an electronic invitation to the client.

5. The system of claim 3, wherein the other user and the user are a same party.

6. The system of claim 3, wherein the electronic communication further specifies an identification of the vendor of the product; and wherein the application module further stores additional instructions allowing the server to:
send a selling request to the vendor identified, the selling request notifying the vendor that the agent has specified the referred product corresponding to a product selected from products offered for sale by the vendor.

7. The system of claim 6, wherein the selling request further specifies a requested commission of the agent, for approbation by the vendor identified.

8. The system of claim 3, further comprising a vendor account module, and wherein the application module further stores additional instructions allowing the server to:
register account information of the other user on the vendor account module, the account information comprising the identification of the vendor.

9. The system of claim 1, further comprising an account module, and wherein the application module further stores additional instructions allowing the server to:
generate a web page associated with at least one of the agent and the vendor, for respectively displaying at least one of the referred product and the products to users; and store the web page on the account module.

10. The system of claim 1, wherein the application module further stores additional instructions allowing the server to:
link the server with an external server hosting an affiliate web site, the affiliate web site displaying at least one of: the product offered for sale by the vendor, and the referred product of the agent.

11. The system of claim 1, further comprising a payment module for processing the purchase request once validated by the vendor; and an account database for recording the electronic notification outputted for that purchase request.

12. The system of claim 1, wherein the electronic communication comprises a digital content specifying the referred product as corresponding to a product sold by a potential vendor, and identification information of the potential vendor.

13. The system of claim 12, wherein the application module stores additional instructions allowing the server to:
send an electronic invitation to join the COBANET to the potential vendor using the identification information.

14. In a server allowing electronic communications thereto and therefrom, a method for implementing a commission-based network (COBANET) over the data communication network, the method comprising:
storing on a memory device accessible by the server, pricing information and commission information associated with products offered for sale by a vendor;
receiving an electronic communication from a user acting as an agent, the electronic communication specifying a referred product corresponding to a product selected from products offered for sale by a vendor, and a contact identification;
generating a transaction schedule associated with the referred product, based on the pricing information and the commission information;
upon receiving an electronic purchase request for the referred product, from a buyer corresponding to the contact identification, determining: a purchase price required from the buyer; a commission for the agent; and a payment due to the vendor, based on the transaction schedule; and
outputting an electronic notification over the data communication network, the electronic notification being indicative of at least one of the commission and the payment for respectively at least one of the agent and the vendor.

15. The method of claim 14, further comprising sending an electronic invitation to the buyer using the contact information, the electronic invitation enticing the buyer to visit a web page of the agent displaying the referred product to purchase the referred product.

16. The method of claim 14, wherein the storing comprises receiving an other electronic communication from an other user acting as the vendor, the other electronic communication detailing the products offered for sale, the pricing information and the commission information.

17. The method of claim 16, further comprising sending an electronic invitation to a client of the vendor, the other electronic communication further comprising an identification of the client.

18. The method of claim 14, wherein the electronic communication further specifies an identification of the vendor of the product; the method further comprising: sending a selling request to the vendor, the selling request notifying the vendor that the agent has specified the referred product corresponding to a product selected from products offered for sale by the vendor.

19. The method of claim 18, wherein the selling request specifies a requested commission of the agent, for approval by the vendor.

20. The method of claim 14, further comprising generating a web page associated with at least one of the agent and the vendor; and sending the web page for display on computing devices of users accessing the server, the web page respectively displaying at least one of the referred products and the products.

21. The method of claim 14, further comprising processing the purchase request and transferring the commission to the agent upon validation of the purchase request by the vendor, using an electronic payment module.

22. The method of claim 14, wherein multiple agents each specify the referred product, the method further comprising determining the agent associated with the purchase request based on a degree of separation between the buyer and each one of the multiple agents.

23. The method of claim 14, wherein the referred product corresponds to a product selected from the products offered for sale by multiple vendors, the method further comprising determining the vendor associated with the purchase request based on a preference rating for each one of the multiple vendors, as provided by the agent.

24. The method of claim 14, further comprising linking the server with an external server hosting an affiliate web site, the affiliate web site displaying at least one of: the product offered for sale by the vendor, and the referred product of the agent.

25. The method of claim 14, wherein the electronic communication comprises a digital content specifying the referred product as corresponding to a product sold by a potential vendor, and identification information of the potential vendor.

26. The method of claim 25, further comprising:
sending an electronic invitation to join the COBANET, to the potential vendor associated with the identification information.
